(19) United States
(12) Patent Application Publication
(10) Pub. No.: US 2021/0221542 A1
(43) Pub. Date: Jul. 22, 2021

(54) ULTRA-CLEAN OR ASEPTIC CHAMBER POUCH FILLING MACHINE

(71) Applicant: GUALA PACK S.P.A., Castellazzo Bormida (Alessandria) (IT)

(72) Inventor: Walter PRESOTTO, Castellazzo Bormida (Alessandria) (IT)

(21) Appl. No.: 17/059,101

(22) PCT Filed: May 10, 2019
(86) PCT No.: PCT/IB2019/053871

§ 371 Date: Nov. 25, 2020

(30) Foreign Application Priority Data
May 30, 2018 (IT) 102018000005871

(51) Int. Cl. B65B 7/28; B65B 55/02; B65B 43/60

(52) U.S. Cl. CPC B65B 7/2807; B65B 43/60; B65B 55/027

(57) ABSTRACT

A pouch filling machine, of ultra-clean type or with aseptic chamber, includes a cap feeding head for application to a flexible pouch with spout, a cap passage, and snap-retaining means for releasably retaining a cap ready for release. The snap-retaining means include a pair of grippers. Each gripper has an end portion protruding from an outlet port of the cap passage and consists of a sheet having at least one flexible portion adapted to bend due to advancement of the cap ready for release.

The present invention relates to the field of filling thin-walled flexible bags, usually called pouches. In particular, the present invention relates to a caps feeding head for a machine for filling pouches with spout with products such as fruit juices, yoghurt, fruit puree, and the like.

The present invention is therefore directed in particular to the food sector, in which, as is known, all the product packaging steps must take place in optimal hygienic conditions.

For this reason, the machines dedicated to filling provide the possibility of carrying out cleaning cycles, which usually involve sprinkling some parts, those most subject to the accumulation of product residues, with sanitizing agents, such as hydrogen peroxide.

In this context, however, it is essential that the components of the machine subject to being soiled by the product are adequately designed, so that all surfaces are easily reachable by the sanitizing agents and the cleaning cycle is effective.

Often, the filling machines require, immediately after the pouch filling step, the application of a cap, brought to the application area by a feeding head. This head is one of the components most subject to be soiled by the product, as it cooperates with the newly filled pouch, which could carry product residues therewith; it is therefore appropriate that it be properly designed.

The object of the present invention is to provide a cap feeding head for a pouch filling machine, which is particularly suitable for use in the food sector.

Such an object is achieved by a feeding head according to claim 1. The dependent claims describe further advantageous embodiment variants.

The features and the advantages of the cap feeding head according to the present invention will appear more clearly from the following description, made by way of an indicative and non-limiting example with reference to the following figures, in which:

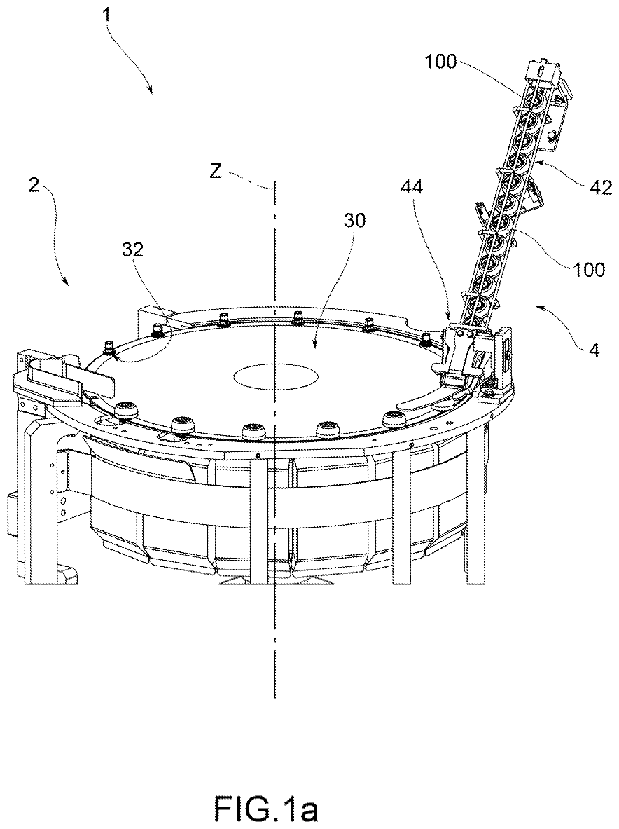

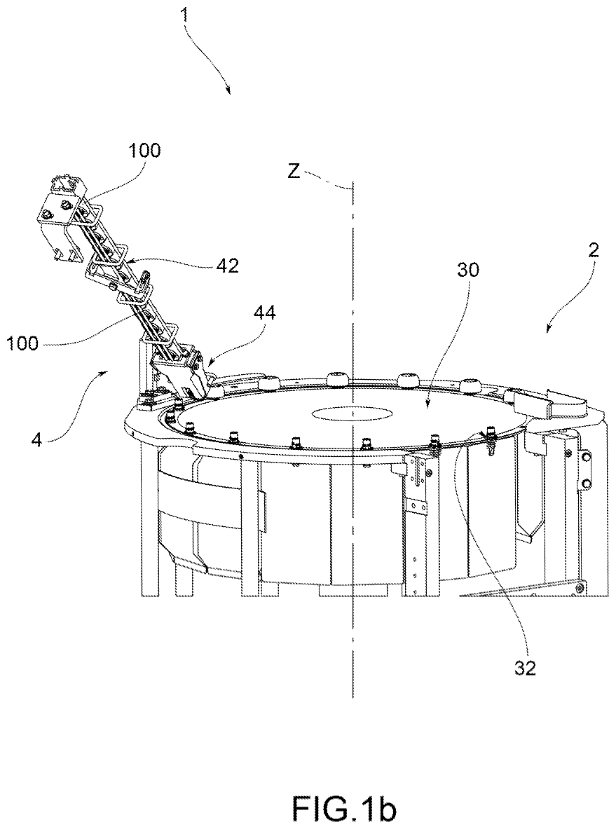

FIGS. 1a and 1b show a filling apparatus comprising a cap feeding head according to an embodiment of the present invention;

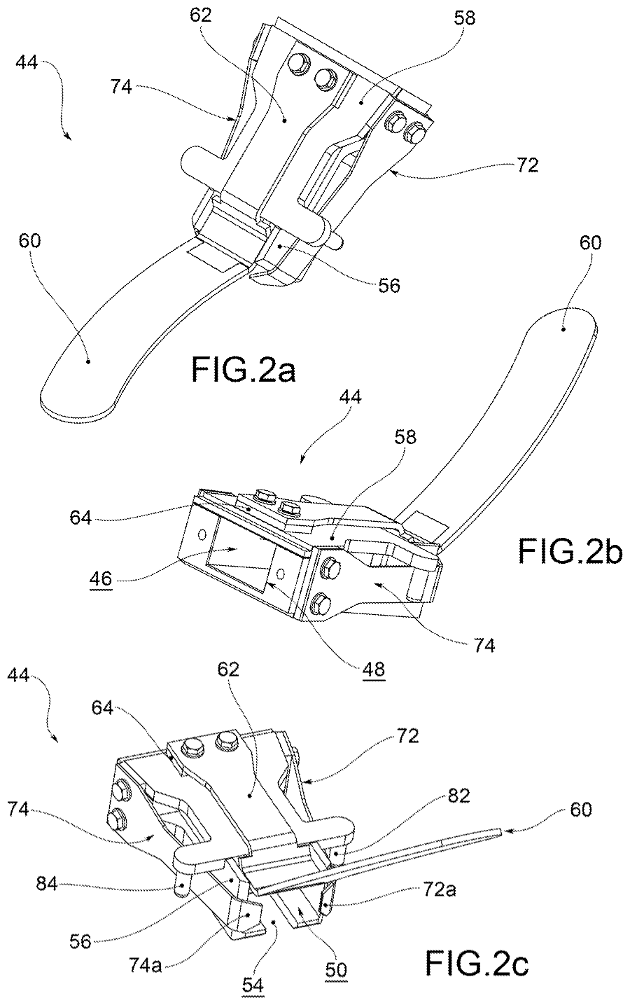

FIGS. 2a to 2c show the cap feeding head according to an embodiment of the present invention;

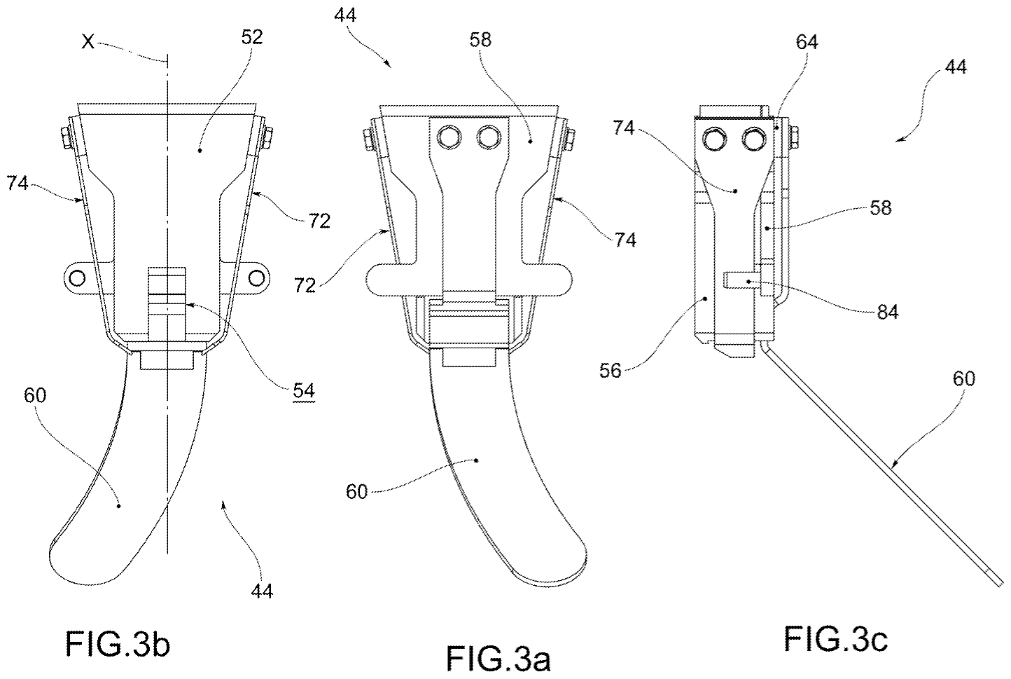

FIGS. 3a to 3c show plan views from above, from below and from the side, respectively, of the cap feeding head according to the present invention;

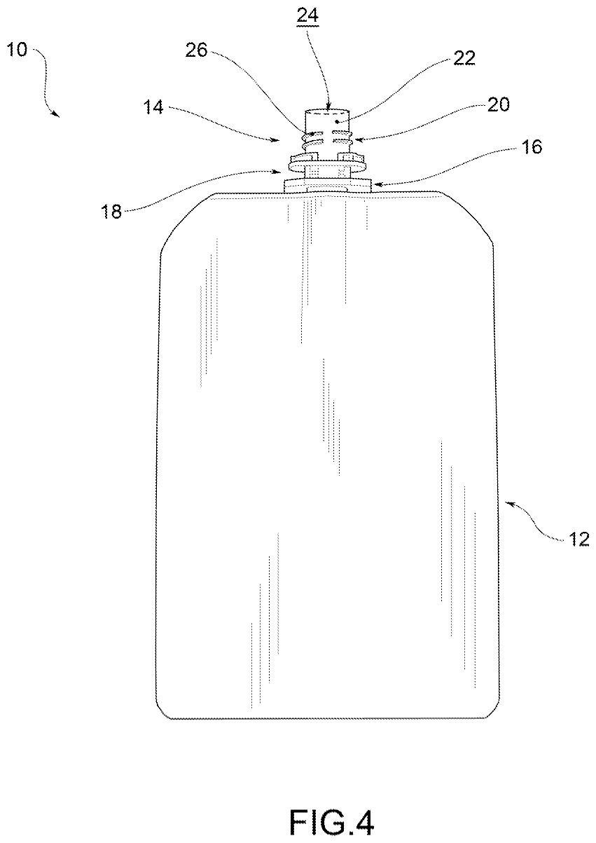

FIG. 4 shows a schematic view of a thin-walled flexible bag (pouch) provided with a spout.

With reference to the accompanying drawings, reference numeral 1 generally indicates a filling apparatus, comprising a filling machine 2 and a cap feeding group 4.

The apparatus 1 is intended for filling flexible bags with thin walls, in jargon called pouches, provided with a spout. In particular, a pouch 10 comprises a pouch body 12, made by thin walls consisting of a film, and a spout 14, typically welded to the upper edges of the pouch body 12.

According to a preferred embodiment, the spout 14 comprises a connecting portion 16, generally referred to as the “welding boat”, to which the edges of the pouch 12 are welded, an intermediate portion 18 and an end portion 20, consisting of a tube 22 ending with a mouth 24. Preferably, the end portion 20 is provided with an outer thread 26 carried by the tube 22, for the application of a cap.

The filling machine 2 comprises a rotary table 30, rotatable about a central vertical axis Z, for example with unidirectional intermittent motion, according to a predefined direction of rotation. The table 30 is peripherally provided with a plurality of seats 32, each seat being designed to load a pouch 10, for example by engaging the intermediate portion 18 of the spout 14.

The machine 2 provides an inlet station in a predefined fixed angular position; when an empty seat 32 of the table 30 passes through the inlet station, it receives an empty pouch 10, which is thus carried by the table 30 through the successive stations for filling and applying a cap.

For example, filling takes place in a split manner among several stations.

At the end of the filling, the full pouch 10 passes through an engagement station of the machine 2, in which the tube 22 of the spout 14 engages with a cap ready for release carried by the feeding group 4, and draws said cap away therewith.

The feeding group 4 comprises a track 42, arranged in descent, inside which the caps 100 to be applied are arranged in succession. The caps 100 are loaded onto the track 42 from above, while a feeding head 44 of the group 4 is applied at the bottom at said engagement station.

The feeding head 44 has a box-like structure, internally crossed by a cap passage 46 which extends downwards from an inlet port 48, where the track 42 is connected, to an outlet port 50, along a straight longitudinal direction X.

The cap passage 46 is sized and delimited according to the shape of the cap, so as to allow the arrival at the outlet port 50 and the outlet therefrom of only one cap at a time.

The cap passage 46 is delimited at the bottom by a bottom plate 52 which supports the cap during the passage, provided, in the proximity of the outlet port 50, with an engagement channel 54 formed through the thickness of the bottom plate 52, so as to allow the passage of the tube 22 of the spout 14 to engage a cap ready for release from the head 44.

Laterally, the cap passage 46 is delimited by side walls 56.

According to a preferred embodiment, the cap passage 46 provides an inlet compartment, into which the inlet port 48 opens, wider transversely, so as to allow the entry of a cap without obstacles, and a subsequent outlet compartment, provided with the outlet port 50, narrower so as to position the cap optimally with respect to the spout 14 in transit.

There is therefore a narrowing between the inlet compartment and the outlet compartment, for example formed by converging portions of the side walls 56.

Above, the cap passage 46 is delimited by an upper plate 58.

Preferably, the bottom plate 52 and/or the side walls 56 and/or the upper plate 58 are made of metal material, preferably of stainless steel; the head 44 also preferably comprises a plurality of gaskets, for example made of silicone, placed between the bottom plate 52 and/or the side walls 56 and/or the upper plate 58, to prevent contact, once assembled, between metal surfaces.

According to a preferred embodiment, the head 44 comprises an abutment tongue 60, consisting of a plate-like element which extends along the path of the spout engaged with the cap, at a predefined height with respect to the table 30, so as to prevent the cap, dragged by the spout but not yet screwed to the tube, from disengaging from the spout itself (for example, due to vibrations).

Preferably, the head 44 comprises a tongue support 62, consisting of a flexible sheet, which supports the abutment tongue 60.

For example, the tongue support 62 extends up to delimit the outlet port 50 at the top, for example starting from the inlet port 48.

Preferably, the tongue support 62 is connected by threaded connections to the upper plate 58, at the inlet port 48.

Preferably, moreover, the tongue support 62 is made of a metal material, for example of stainless steel, and between the tongue support 62 and the upper plate 58 there is a gasket 64, for example of silicone, to prevent direct contact between metal surfaces.

The head 44 further comprises retaining means, operating at the outlet port 50, suitable for retaining a cap ready for release in a releasable manner.

In particular, said retaining means operate in a snap action and are suitable for retaining the cap ready for release until the intensity of the action exerted by the spout in transit on the cap is less than a predefined threshold value; when the intensity of the action exerted by the spout in transit on the cap is greater than or equal to said predefined threshold value, the retaining means release the cap ready for release.

According to a preferred embodiment, said retaining means comprise a pair of grippers 72, 74, each consisting of a flexible sheet, comprising an end portion 72a, 74a projecting at the sides of the outlet port 50, configured so as to hold the cap ready for release.

Preferably, each gripper 72, 74 extends longitudinally from the inlet port 48 to the outlet port 50, and is fixed for example to the respective side wall 56, preferably by threaded connections, for example at the inlet port 48.

Preferably, each gripper 72, 74 is made of metal material, for example of stainless steel, and said retaining means comprise gaskets 72b, 74b, for example made of silicone, placed between the gripper 72, 74 and the respective side wall 56, to prevent contact between metal surfaces.

According to a preferred embodiment, furthermore, said retaining means comprise limiting means suitable for limiting the deformation of the grippers 72, 74 to prevent yielding thereof.

For example, said limiting means comprise a pair of pins 82, 84, each pin 82, 84 being arranged externally to the respective gripper 72, 74 with respect to the cap passage 46, at a predefined distance, so that the gripper, in a configuration of maximum deformation, abuts on said pin.

Preferably, each pin 82, 84 is supported by the upper plate 58.

According to different embodiments, the feeding head described above is used within an ultra-clean or aseptic chamber filling machine.

Innovatively, the feeding head according to the present invention meets the needs of the food industry, since all the areas subject to being soiled by the product are reachable by the sanitizing agents during spraying.

Advantageously, moreover, the feeding head is free of springs, for example helical, for the retaining means; notoriously, these springs are difficult to sanitize, due to the tendency to incorporate dirt into recesses that cannot be reached by spraying.

According to a further advantageous aspect, the feeding head is free of metal surfaces in contact with each other.

It is clear that a man skilled in the art may make changes to the feeding head described above in order to meet incidental needs, all falling within the scope of protection defined in the following claims.

1-11. (canceled)

12. A filling apparatus comprising:
a pouch filling machine with an ultra-clean or an aseptic chamber filling system, the pouch filling machine comprising a table rotatable around a central vertical axis (Z), peripherally provided with a plurality of seats, each seat being suitable for engaging a spout of a pouch, said pouch filling machine being provided, in a predefined angular position, with a cap engagement station; and
a cap feeding group comprising:
A) a track, arranged in descent, suitable for containing caps to be applied;
B) a cap feeding head arranged at said cap engagement station, applied to a lower end of the track, the cap feeding head comprising:
a) a descending cap passage for advancement by gravity of said caps, extending along a longitudinal direction (X) between an inlet port of the track and an outlet port of the track, and shaped for release of one cap at a time;
b) snap-retaining means suitable for releasably retaining a cap ready for release, said snap-retaining means comprising a pair of grippers, wherein each gripper comprises an end portion protruding from the outlet port, and consists of a sheet having at least one flexible portion adapted to bend due to advancement of said cap ready for release to release it, said snap-retaining means further comprising limiting means suitable for limiting deformation of the pair of grippers to prevent yielding thereof, said limiting means comprising a pair of pins, each pin being arranged externally to a respective gripper with respect to the descending cap passage, at a predefined distance, so that the gripper, in a configuration of maximum deformation, abuts on said pin, each pin being supported by an upper plate;
wherein:
the descending cap passage is delimited at the bottom by a bottom plate supporting the cap during passage, provided, in proximity of the outlet port, with an engagement channel formed through a thickness of the bottom plate, to allow passage of a tube of the spout to engage the cap ready for release from the cap feeding head,
the descending cap passage is delimited by side walls,
the descending cap passage comprises:
an inlet compartment, transversely wider, the inlet port opening in said inlet compartment, to allow entry of the cap without obstacles, and
an outlet compartment, provided with the outlet port, the outlet compartment being narrower to optimally position the cap with respect to a transiting spout, converging portions of the side walls forming a narrowing between the inlet compartment and the outlet compartment,
the descending cap passage is delimited at the top by an upper plate, wherein the bottom plate, the side walls and the upper plate are made of metal material, and wherein the cap feeding head further comprises a plurality of gaskets, placed between the bottom plate and the side walls and the upper plate, to prevent contact, once assembled, between metal surfaces.

13. The filling apparatus of claim 12, further comprising a plurality of gaskets, made of silicone, placed between the pair of grippers and respective side walls, each gripper being made of metal material, to prevent contact between metal surfaces.

14. The filling apparatus of claim 12, further comprising a tongue support for an abutment tongue suitable for limiting a stroke of the cap on the spout, the tongue support consisting of a flexible sheet.

15. The filling apparatus of claim 14, wherein the tongue support comprises a portion delimiting the outlet port at the top.
